(19) United States
(12) Patent Application Publication
(10) Pub. No.: US 2013/0173855 A1
(43) Pub. Date: Jul. 4, 2013

(54) METHOD OF OPERATING STORAGE DEVICE INCLUDING VOLATILE MEMORY AND NONVOLATILE MEMORY

(71) Applicant: SAMSUNG ELECTRONICS CO., LTD., Suwon-si (KR)

(72) Inventors: Jae-Geuk Kim, Hwaseong-si (KR); Joo-Young Hwang, Suwon-si (KR)

(73) Assignee: SAMSUNG ELECTRONICS CO., LTD., SUWON-SI (KR)

(21) Appl. No.: 13/727,744

(22) Filed: Dec. 27, 2012

(30) Foreign Application Priority Data
Jan. 3, 2012 (KR) 10-2012-0000353

(51) Int. Cl. G06F 12/02

(52) U.S. Cl. CPC G06F 12/0246
USPC 711/103

(57) ABSTRACT

For a storage device including a volatile memory and a nonvolatile memory, an operating method includes partitioning the volatile memory into volatile memory blocks in response to a first control command, and then performing a data read operation, a data write operation, or a data migration operation by using at least one of the volatile memory blocks.

### CROSS-REFERENCE TO RELATED APPLICATION

This application claims priority under 35 USC §119 to Korean Patent Application No. 2012-0000353 filed on Jan. 3, 2012, the subject matter of which is hereby incorporated by reference.

### BACKGROUND

Embodiments of the inventive concept relate generally to storage devices, and more particularly to methods of operating storage devices that include a volatile memory and a nonvolatile memory.

Portable electronic devices have become a mainstay of modern consumer demand. Many portable electronic devices include a data storage device configured from one or more semiconductor memory device(s) instead of the conventional hard disk drive (HDD). The so-called solid state drive (SSD) is one type of data storage device configured from one or more semiconductor memory device(s). The SSD enjoys a number of design and performance advantages over the HDD, including an absence of moving mechanical parts, higher data access speeds, improved stability and durability, low power consumption, etc. Accordingly, the SSD is increasingly used as a replacement for the HDD and similar conventional storage devices. In this regard, the SSD may operate in accordance with certain standardized host interface(s) such as Parallel Advanced Technology Attachment (PATA) or Serial Advanced Technology Attachment (SATA).

As is conventionally appreciated, the SSD usually includes both nonvolatile and volatile memories. The nonvolatile memory is typically used as the primary data storage medium, while the volatile memory is used as a data input and/or output (I/O) buffer memory (or “cache”) between the nonvolatile memory and a controller or interface. Use of the buffer memory improves overall data access speed within the SDD.

### SUMMARY

Accordingly, the inventive concept is provided to substantially obviate one or more problems due to limitations and disadvantages of the related art.

In one embodiment, the inventive concept provides a method of operating a storage device including a volatile memory and a nonvolatile memory, the method comprising; receiving a first control command from a host, partitioning the volatile memory into a plurality of volatile memory blocks in response to the first control command; and thereafter, performing a data read operation that retrieves read data from the nonvolatile memory, stores the retrieved read data in a first volatile memory block among the plurality of volatile memory blocks, and then provides the read data stored in the first volatile memory block to the host.

In another embodiment, the inventive concept provides a method of operating a storage device including a volatile memory and a nonvolatile memory, the method comprising; receiving a first control command from a host, partitioning the volatile memory into a plurality of volatile memory blocks in response to the first control command; and thereafter, performing a data write operation that stores write data received from the host in a first volatile memory block among the plurality of volatile memory blocks, and then stores the write data stored in the first volatile memory block in the nonvolatile memory.

In another embodiment, the inventive concept provides a method of operating a storage device including a volatile memory and a nonvolatile memory, the method comprising; partitioning the volatile memory into a plurality of volatile memory blocks including a first volatile memory block and a second volatile memory block, and thereafter, performing a data migration operation. The data migration operation comprising; reading first data from a first data storage area of the nonvolatile memory and storing the first data in the first volatile memory block, accumulating the first data in an allocation area of the second volatile memory block as second data, and then, storing at least a portion of the second data in a second data storage area of the nonvolatile memory different from the first data storage area.

### BRIEF DESCRIPTION OF THE DRAWINGS

Illustrative, non-limiting embodiments of the inventive concept will be more clearly understood from the following detailed description taken in conjunction with the accompanying drawings.

FIG. 1 is a flow chart summarizing a method of operating a storage device including a volatile memory and a nonvolatile memory according to an embodiment of the inventive concept.

FIG. 2 is a block diagram illustrating a computational system including a storage device operated in accordance with an embodiment of the inventive concept.

FIGS. 3 and 4 are conceptual diagrams further illustrating the operating method of FIG. 1.

FIGS. 5 and 6 are flow charts more particularly describing in two examples the step of performing a data read operation or data write operation in the operating method of FIG. 1.

FIG. 7 is a flow chart summarizing a method of operating a storage device including a volatile memory and a nonvolatile memory according to another embodiment of the inventive concept.

FIG. 8 is a flow chart more particularly describing in one example the step of performing data migration in the operating method of FIG. 7.

FIGS. 9A, 9B, 9C and 9D are conceptual diagrams further illustrating the operating method of FIG. 7.

FIG. 10 is a flow chart more particularly describing in one example the step of performing data migration in the operating method of FIG. 7.

FIGS. 11A, 11B, 11C and 11D are conceptual diagrams still further illustrating the operating method of FIG. 7.

FIGS. 12 and 13 are block diagrams illustrating computational systems including one or more storage device(s) according to embodiments of the inventive concept.

FIG. 14 is a diagram illustrating a memory card including one or more storage device(s) according to embodiments of the inventive concept.

FIG. 15 is a diagram illustrating an embedded multimedia card including one or more storage device(s) according to embodiments of the inventive concept.

FIG. 16 is a diagram illustrating a solid state drive including one or more storage device(s) according to embodiments of the inventive concept.

FIG. 17 is a block diagram illustrating a system including one or more storage device(s) according to embodiments of the inventive concept.

FIG. 18 is a block diagram illustrating a storage server including one or more storage device(s) according to embodiments of the inventive concept.

FIG. 19 is a block diagram illustrating a server system including one or more storage device(s) according to embodiments of the inventive concept.

### DETAILED DESCRIPTION

Certain embodiments of the inventive concept will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the scope of the inventive concept to those skilled in the art. Throughout the written description and drawings, like reference number and labels are used to denote like or similar elements and method steps.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

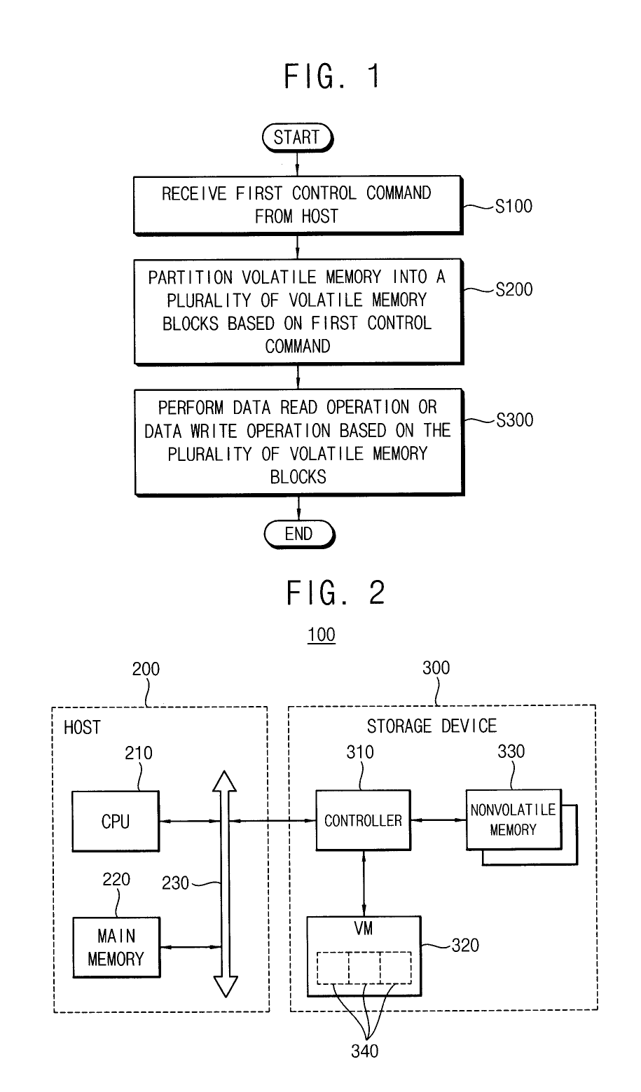

FIG. 1 is a flow chart summarizing a method of operating a storage device including a volatile memory and a nonvolatile memory according to an embodiment of the inventive concept.

The method illustrated in FIG. 1 may be applied to control the operation of (or “drive”) a storage device including a semiconductor volatile memory and a semiconductor nonvolatile memory. Hereinafter, the method of operating a storage device according to embodiments of the inventive concept will be described in the context of an exemplary solid state drive (SSD). However, operating methods consistent with embodiments of the inventive concept may be applied in other types of storage devices, such as a memory card, etc.

Referring to FIG. 1, the operating method for a storage device begins when a first control command is received from a host (S 100). A volatile memory is partitioned into a plurality of “volatile memory blocks” in response to the first control command (S200). Then, a data read operation or a data write operation is performed using the plurality of volatile memory blocks (S300). The data read operation retrieves “read data” previously stored in the nonvolatile memory and provides it to the requesting host. The data write operation causes “write data” received from the host to be stored in the nonvolatile memory.

During a data read operation performed in accordance with a conventional operating method for a storage device including volatile and nonvolatile memories, the volatile memory is used as a read cache for read data retrieved from the nonvolatile memory, regardless of data type. During a data write operation performed in accordance with a conventional operating method for a storage device including volatile and nonvolatile memories, the volatile memory is used as a write buffer to hold the write data received from the host, regardless of data type. In other words, the conventional storage device does not efficiently use information regarding the “data type” (e.g., one or more data properties and/or characteristics) to manage use of the volatile memory, despite the fact that information regarding data type may be readily obtained from the host. Thus, when one data type is overly used in the volatile memory of the conventional storage device, the conventional storage device may have relatively low performance with respect to the other data types. This result is referred to as the starvation problem.

In contrast, operating methods for storage devices including the volatile and nonvolatile memories according to embodiments of the inventive concept, partition the volatile memory in response to an externally provided command. For example, the volatile memory may be partitioned into the plurality of volatile memory blocks depending on the data type(s) of the read data identified by a data read operation or the write data identified by a data write operation. Thus, at least one of the volatile memory blocks will be used as a read cache or as a write buffer. As a result, even though one data type may predominate in a number of read/write operations, the volatile memory of storage devices consistent with embodiments of the inventive concept will not suffer from the starvation problem. Storage devices according to certain embodiments of the inventive concept provide relatively high data security because data may be separately according to type(s). In addition, storage devices according to embodiments of the inventive concept allow the efficient use of data type information, as managed by the host, to provide improved performance.

FIG. 2 is a block diagram illustrating in part an exemplary computational system capable of being operated using the operating method of FIG. 1.

Referring to FIG. 2, a computational system 100 generally includes a host 200 and a storage device 300.

The host 200 may include a processor 210, a main memory 220 and a bus 230. The processor 210 may perform various computing functions, such as executing specific software for performing specific calculations or tasks. The processor 210 may execute an operating system (OS) and/or applications that are stored in the main memory 220 or in another memory included in the host 200. For example, the processor 210 may be a microprocessor, a central process unit (CPU), or the like.

The processor 210 may be connected to the main memory 220 via the bus 230, such as an address bus, a control bus and/or a data bus. For example, the main memory 220 may be implemented using a semiconductor memory device like the dynamic random access memory (DRAM), static random access memory (SRAM), mobile DRAM, etc. In other examples, the main memory 220 may be implemented using a flash memory, a phase random access memory (PRAM), a ferroelectric random access memory (FRAM), a resistive random access memory (RRAM), a magnetic random access memory (MRAM), etc.

The storage device 300 may include a controller 310, at least one volatile memory 320 and at least one nonvolatile memory 330. The controller 310 may receive a command from the host 200, and may control an operation of the storage device 300 in response to the command.

The volatile memory 320 may serve as a write buffer temporarily storing write data provided from the host 200 and/or as a read cache temporarily storing read data retrieved from the nonvolatile memory 330. In some embodiments, the volatile memory 320 may store an address translation table to translate a logical address received from the host 200 in conjunction with write data or read data into a physical address for the nonvolatile memory 330. In certain embodiments, the volatile memory 320 may be implemented using one or more DRAM or SRAM. Although FIG. 2 illustrates an example where the volatile memory 320 is located external to the controller 310, in some embodiments, the volatile memory 320 may located internal to the controller 310.

The nonvolatile memory 330 may be used to store write data provided from the host 200, and may be subsequently used to provide requested read data. The nonvolatile memory 330 will retain stored data even in the absence of applied power to the nonvolatile memory 330. Hence, the nonvolatile memory 330 may be implemented using one or more NAND flash memory, NOR flash memory, PRAM, FRAM, RRAM, MRAM, etc.

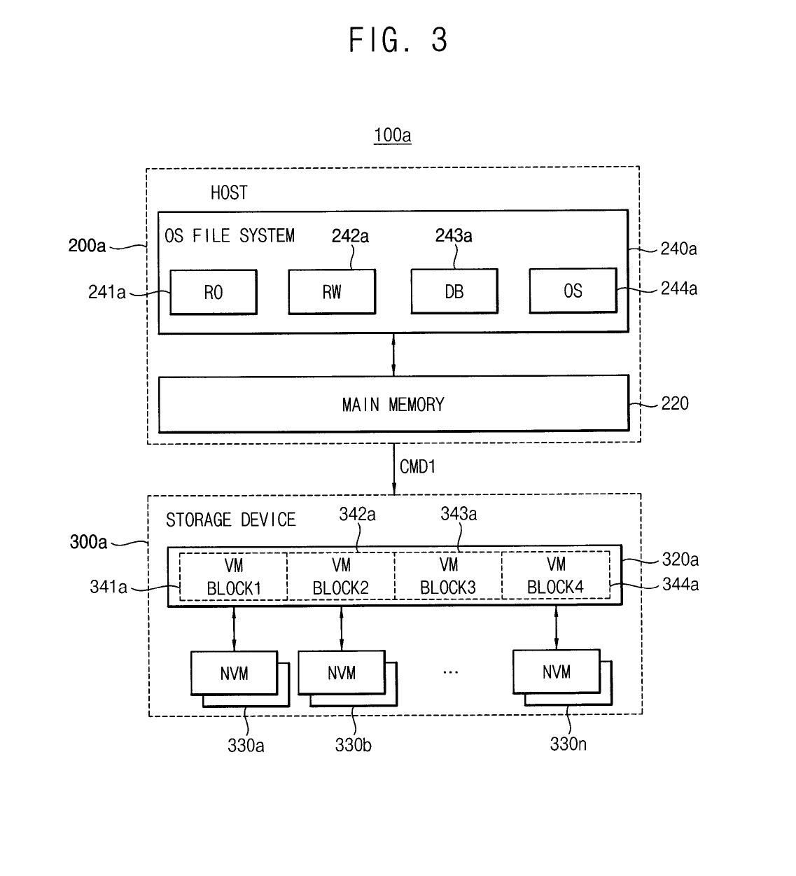

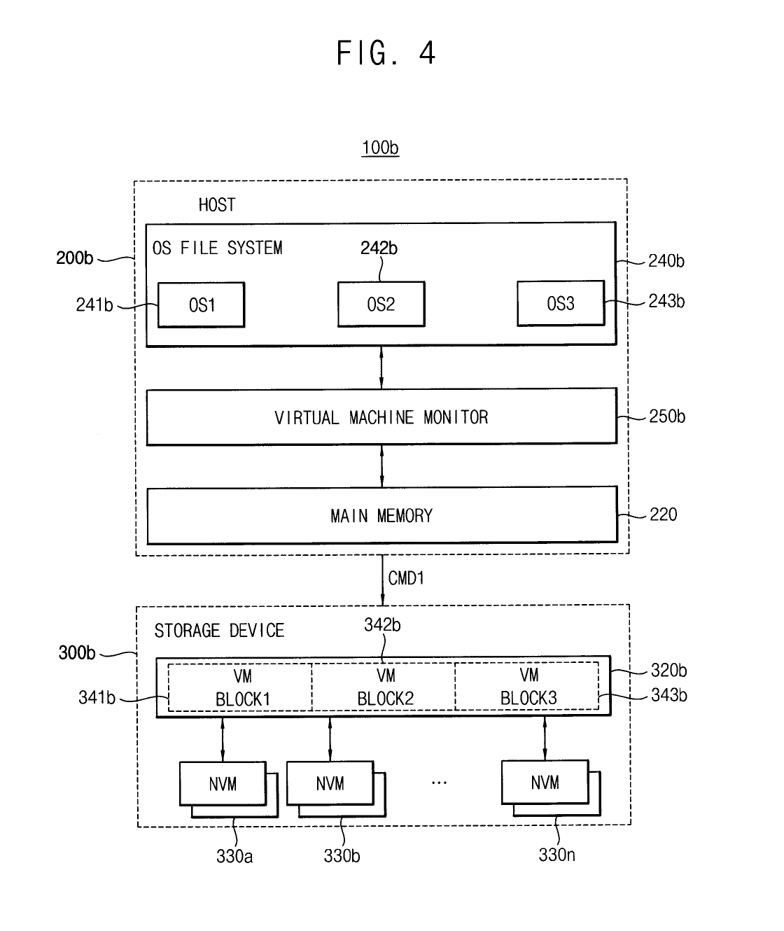

With reference to FIGS. 1 and 2, the controller 310 receives the first control command from the host 200, and partitions the volatile memory 320 into a plurality of volatile memory blocks 340. The first control command (e.g., a volatile memory configuration command) may include various information with respect to the plurality of volatile memory blocks 340. For example, the first control command may include information with respect to the number of the plurality of volatile memory blocks 340, type designations for the plurality of volatile memory blocks 340, management policies for the plurality of volatile memory blocks 340, and the respective size(s) of the plurality of volatile memory blocks 340, etc. The “type designation” for each volatile memory block 340 may be read only type, read/write type, database type, guest OS type, etc. The management policy of each volatile memory block 340 may include a least recently used (LRU) algorithm, a most recently used (MRU) algorithm, a first-in first-out (FIFO) algorithm, etc. Examples of possible volatile memory configuration commands will be described in some additional detail with reference to FIGS. 3 and 4.

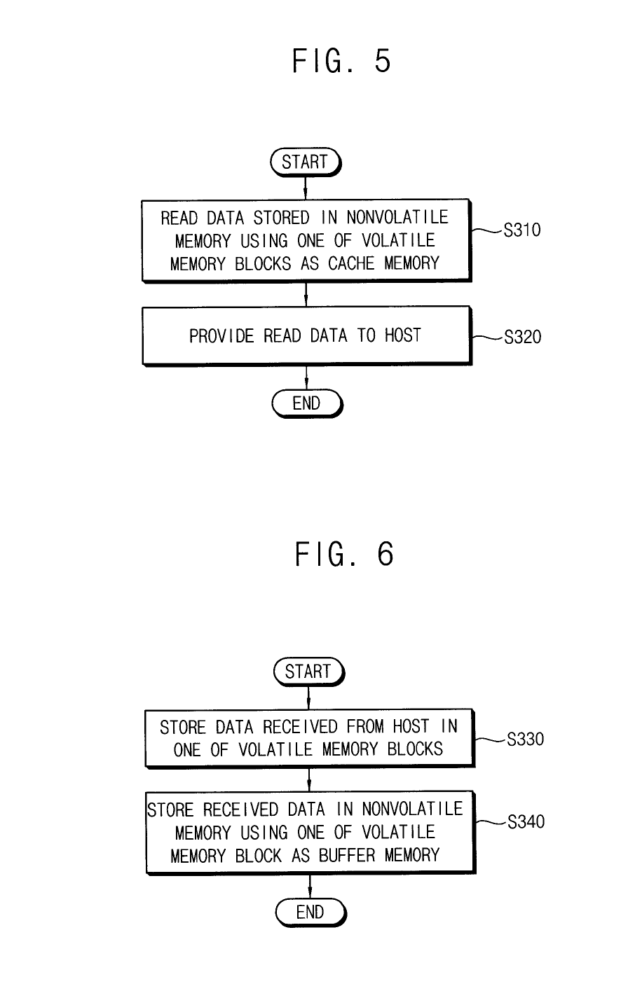

The controller 310 may perform a data read operation or a data write operation in view of the configuration of the plurality of volatile memory blocks 340. For example, the controller 310 may perform the data read operation using at least one of the volatile memory blocks 340 as the read cache depending on the type(s) of read data. Alternately, the controller 310 may perform the data write operation using at least one of the volatile memory blocks 340 as the write buffer depending on the type(s) of write data. Thus, the storage device 300 may provide relatively improved performance and relatively better data security within the computational system 100. Examples of possible data read operations and data write operations will be described in some additional detail with reference to FIGS. 5 and 6.

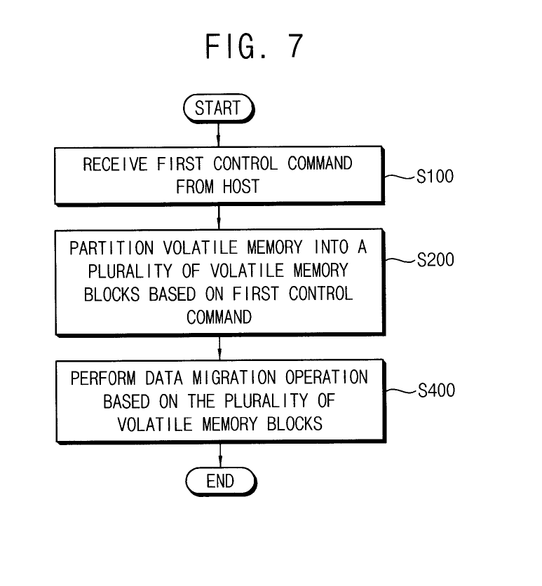

Further, in certain embodiments, the controller 310 may perform a data migration in view of the configuration of the plurality of volatile memory blocks 340. An exemplary data migration operation will be described in some additional detail with reference to FIG. 7.

FIGS. 3 and 4 are conceptual diagrams further illustrating the method of FIG. 1. That is, FIGS. 3 and 4 further illustrate a volatile memory included in a storage device according to certain embodiments of the inventive concept following partition into a plurality of volatile memory blocks depending on data type(s).

Referring to FIG. 3, a computational system 100a includes a host 200a and a storage device 300a.

The host 200a includes an OS file system 240a and a main memory 220. The storage device 300a includes a volatile memory 320a and a plurality of nonvolatile memories 330a, 330b, . . . , 330n. For convenience of illustration, a processor understood to be included in the host 200a and a controller understood to be included in the storage device 300a are omitted from the illustration of FIG. 3.

The OS file system 240a may be included in the OS that is executed by the processor and may be stored in the main memory 220 or in another memory included in the host 200a. The data accessed by the computational system 100a may be categorized into read only (RO) type 241a, read/write (RW) type 242a, a database (DB) type 243a and an OS type 244a, depending on the workload of the OS file system 240a.

The host 200a provides a first control command (e.g., a nonvolatile memory configuration command) CMD1 to the storage device 300a. The volatile memory 320a in the storage device 300a is partitioned into a plurality of volatile memory blocks 341a, 342a, 343a, 344a in response to the first control command CMD1. For example, the first control command CMD1 may be defined according to the following:

CMD1=VM_Partition(N,typ[ ],alg[ ],siz[ ]). [Equation 1],

where “VM_Partition” indicates a defined function for partitioning the volatile memory, and “N”, “typ[ ]”, “alg[ ]”, and “siz[ ]” are integer parameters for the function VM_Partition. For example, N may indicate a number of the volatile memory blocks, typ[ ] may indicate the data type(s) that may be stored in each volatile memory block, alg[ ] may be used to indicate a management policy (e.g., a cache management policy) for each one of the volatile memory blocks, and siz[ ] may be used to indicate the respective size(s) (e.g., allocated data storage capacity) for the volatile memory blocks.

In the particular embodiment illustrated in FIG. 3, the first control command CMD1 may be assumed to be: VM_Partition (4, typ[RO, RW, DB, OS], alg[LRU, MRU, FIFO, LRU], siz[200 MB, 200 MB, 1 GB, 1 GB]). That is, the volatile memory 320a may be partitioned into four (4) volatile memory blocks 341a, 342a, 343a, 344a. A first volatile memory block 341a is assigned to read only type data 241a such as system files, meta data, etc., is managed using a LRU algorithm, and has a size of about 200 MB. A second volatile memory block 342a is assigned to read/write type data 242a, is managed using a MRU algorithm, and has a size of about 200 MB. A third volatile memory block 343a is assigned to database type data 243a, is managed using a FIFO algorithm, and has a size of about 1 GB, and a fourth volatile memory block 344a is assigned to OS type data 244a, is managed using a LRU algorithm, and has a size of about 1 GB.

Referring to FIG. 4, a computational system 100b includes a host 200b and a storage device 300b.

The host 200b includes an OS file system 240b, a virtual machine monitor (VMM) 250b and a main memory 220. The storage device 300b includes a volatile memory 320b and a plurality of nonvolatile memories 330a, 330b, . . . , 330n. Again, for convenience of illustration, the processor assumed to be included in the host 200b and the controller assumed to be included in the storage device 300b are omitted from the illustration of FIG. 4.

Similarly to the OS file system 240a in FIG. 3, the OS file system 240b may be included in the OS, and may be stored in the main memory 220 or in another memory included in the host 200b. The computational system 100b may be an OS virtual system, and may include a plurality of guest operating systems 241b, 242b, 243b. The data used in the computational system 100b may be categorized into a first guest OS type data 241b, a second guest OS type data 242b, and a third guest OS type data 243b, depending on a workload of the OS file system 240b. The VMM 250b may perform interfacing between the OS file system 240b and the storage device 300b, and may be implemented by a virtual software such as Xen or VMware.

The host 200b provides a first control command CMD1 to the storage device 300b. The volatile memory 320b in the storage device 300b is partitioned into a plurality of volatile memory blocks 341b, 342b, 343b based on the first control command CMD1. In an embodiment of FIG. 4, the first control command CMD1 may be defined as: VM_Partition (3, typ[OS1, OS2, OS3], alg[LRU, LRU, LRU], siz[1 GB, 1 GB, 1 GB]). That is, the volatile memory 320b may be partitioned into three (3) volatile memory blocks 341b, 342b, 343b. A first volatile memory block 341b is assigned to the first guest OS type data 241b, is managed using a LRU algorithm, and has a size of about 1 GB. A second volatile memory block 342a is assigned to the second guest OS type data 242b, is also managed using a LRU algorithm, and has a size of about 1 GB, and a third volatile memory block 343a is assigned to the third guest OS type data 243b, is managed by a LRU algorithm, and has a size of about 1 GB.

The volatile memory blocks 341a, 342a, 343a, 344a in FIG. 3 and the volatile memory blocks 341b, 342b, 343b in FIG. 4 may operate as a write buffer temporarily storing data provided from the host 200a and 200b and/or as a read cache temporarily storing data output from the nonvolatile memories 330a, 330b, . . . , 330n, depending on the types of data.

Although FIGS. 3 and 4 illustrate examples of a volatile memory being partitioned into four and three volatile memory blocks, the number of volatile memory blocks is not limited thereto.

According to other embodiments of the inventive concept, at least one of the number of the volatile memory blocks, the type(s) of the volatile memory blocks, the management policy for the volatile memory blocks, and the respective size(s) of the volatile memory blocks may be changed according to design requirements. For example, a host may provide certain commands (e.g., a block insertion command, a block deletion command, and a configuration change command) that may indirectly alter the nonvolatile memory configuration in response to changes in the configuration of the nonvolatile memory. Thus, the storage device may add at least one volatile memory block based on the block insertion command, may remove at least one volatile memory block based on the block deletion command, and/or may change at least one of the types, management policies and sizes of the volatile memory blocks based on the change command. In other embodiments, the host may provide certain commands (e.g., a release command and a repartition command) that directly alter the configuration of the nonvolatile memory without necessarily changing the configuration of the nonvolatile memory. For example, the storage device may “release the partition” of the volatile memory based on the release command, or repartition the volatile memory into a plurality of volatile memory blocks in a manner distinct from the previous state based on the repartition command, thereby changing at least one of the number, types, management policies and sizes of the volatile memory blocks.

FIGS. 5 and 6 are flow charts further describing the step of performing a data read operation and the step of performing a data write operation of FIG. 1. FIG. 5 illustrates an example of the data read operation, and FIG. 6 illustrates an example of the data write operation.

Referring to FIGS. 1 and 5, during a data read operation, read data stored in the nonvolatile memory may be read using one of the plurality of volatile memory blocks (e.g., a first volatile memory block) as a cache memory (S310). The type(s) assigned to the first volatile memory block will correspond to the type(s) of the read data.

For example, in relation to the particular embodiment of FIG. 3, read only type data stored in the nonvolatile memories 330a, 330b, . . . , 330n may be read using the first volatile memory block 341a as the cache memory, and read/write type data stored in the nonvolatile memories 330a, 330b, . . . , 330n may be read using the second volatile memory block 342a as the cache memory. In relation to the particular embodiment of FIG. 4, the first guest OS type data stored in the nonvolatile memories 330a, 330b, . . . , 330n may be read using the first volatile memory block 341b as the cache memory, and the second guest OS type data stored in the nonvolatile memories 330a, 330b, . . . , 330n may be read using the second volatile memory block 342b as the cache memory.

The read data may then be provided to the host (S320). For example, the controller 310 in FIG. 2 may provide the read data to the host 200 in FIG. 2.

Referring to FIGS. 1 and 6, during a data write operation, write data received from the host may be stored in one of the plurality of volatile memory blocks (e.g., a second volatile memory block) (S330). The type(s) of the second volatile memory block will correspond to the type(s) of the write data. The received write data may be stored in the nonvolatile memory using the second volatile memory block as a buffer memory (S340).

For example, in relation to the particular embodiment of FIG. 3, read/write type data received from the host 200a may be stored in the nonvolatile memories 330a, 330b, . . . , 330n using the second volatile memory block 342a as the buffer memory, and database type data received from the host 200a may be stored in the nonvolatile memories 330a, 330b, . . . , 330n using the third volatile memory block 343a as the buffer memory. In relation to the particular embodiment of FIG. 4, the first guest OS type data received from the host 200b may be stored in the nonvolatile memories 330a, 330b, . . . , 330n using the first volatile memory block 341b as the buffer memory, and the second guest OS type data received from the host 200b may be stored in the nonvolatile memories 330a, 330b, . . . , 330n using the second volatile memory block 342b as the buffer memory.

FIG. 7 is a flow chart summarizing a method of operating a storage device including a volatile memory and a nonvolatile memory according to another embodiment of the inventive concept.

Referring to FIG. 7, in the illustrated operating method for the storage device, a first control command is received from a host (S 100). The volatile memory is partitioned into a plurality of volatile memory blocks in response to the first control command (S200). A data migration operation is performed in view of the plurality of volatile memory blocks (S300). The data migration operation indicates that data stored in a first data storage area of the storage device should move (or “migrate”) to a different (second) data storage area of the storage device in response to a data migration request. Steps S100 and S200 of FIG. 7 may be substantially the same as steps S100 and S200 of FIG. 1, respectively.

In a conventional operating method for a storage device including a volatile memory and a nonvolatile memory, data stored in a first storage area may migrate to a second storage area by first “accumulating” the data in the volatile memory, providing the accumulated data to a host, receiving the accumulated data (or data derived therefrom) back from the host, and then storing the received data in the second storage area using the volatile memory. In other words, during a migration operation performed in a storage device using a conventional operating method, “migrating data” stored in one storage area must move to a different storage area via the host. This requirement ensures relatively low performance with respect to the data migration operation.

In contrast, operating methods for storage devices including volatile and nonvolatile memories according to embodiments of the inventive concept, use a volatile memory that has been coherently partitioned according to externally provided command, and the data stored in one storage area of the volatile memory may be directly migrated to another data storage area without passing through the host. Thus, storage devices and operating methods according to embodiments of the inventive concept provided relatively improved performance during data migration operations, such as a garbage collection operation in a log-based file system and a journal committing operation in a journaling file system.

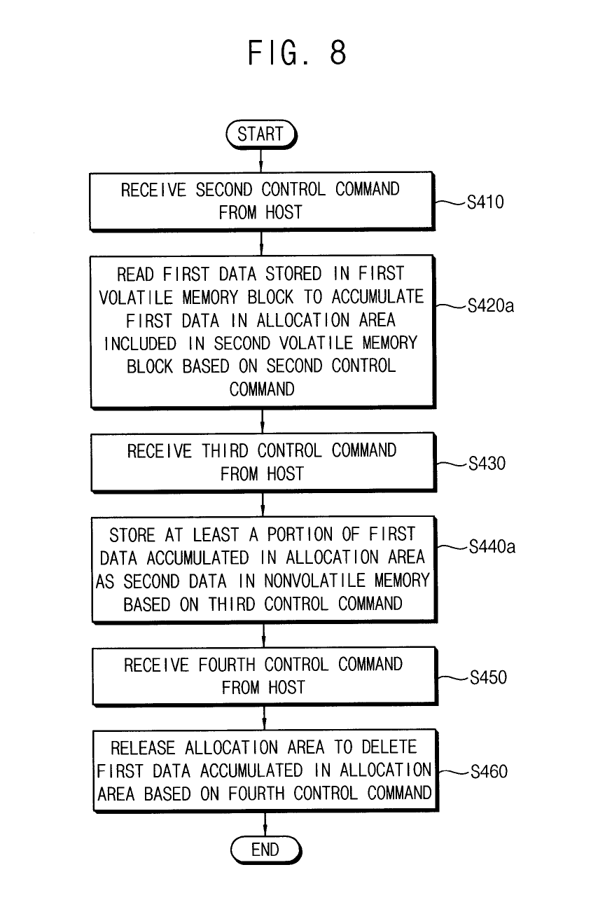

FIG. 8 is a flow chart further describing the step of performing a data migration operation in the operating method of FIG. 7.

Referring to FIGS. 7 and 8, during the data migration operation, a second control command may be received from the host (S410). Read data stored in a first volatile memory block among the plurality of volatile memory blocks may be read/accumulated in a designated “allocation area” of a second volatile memory block among the plurality of volatile memory blocks in response to the second control command (S420a). A third control command is then received from the host (S430). At least a portion of the accumulated-read data (e.g., the data to be migrated) now stored in the allocation area may be stored in the nonvolatile memory as write data in response to the third control command (S440a).

In the illustrated embodiment of FIG. 8, the first volatile memory block that stores the initially retrieved read data may correspond to a first data storage area of the storage device, and the nonvolatile memory that stores the accumulated-read data as the result of the data migration operation may correspond to a second data storage area of the storage device. The second control command may be a data read command, and the third control command may be a data write command. Both the second and third control commands may correspond to the data migration request.

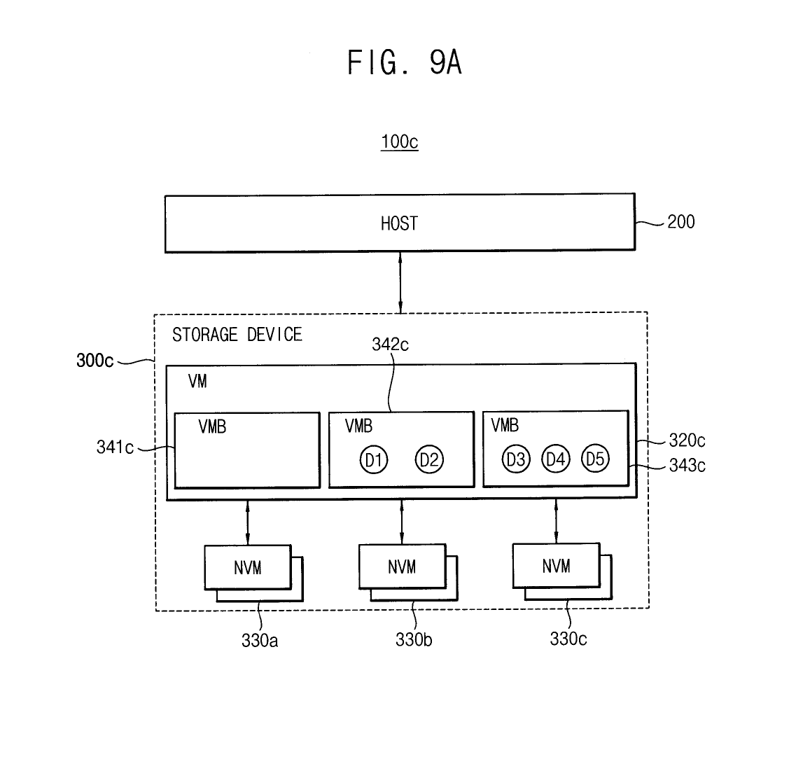

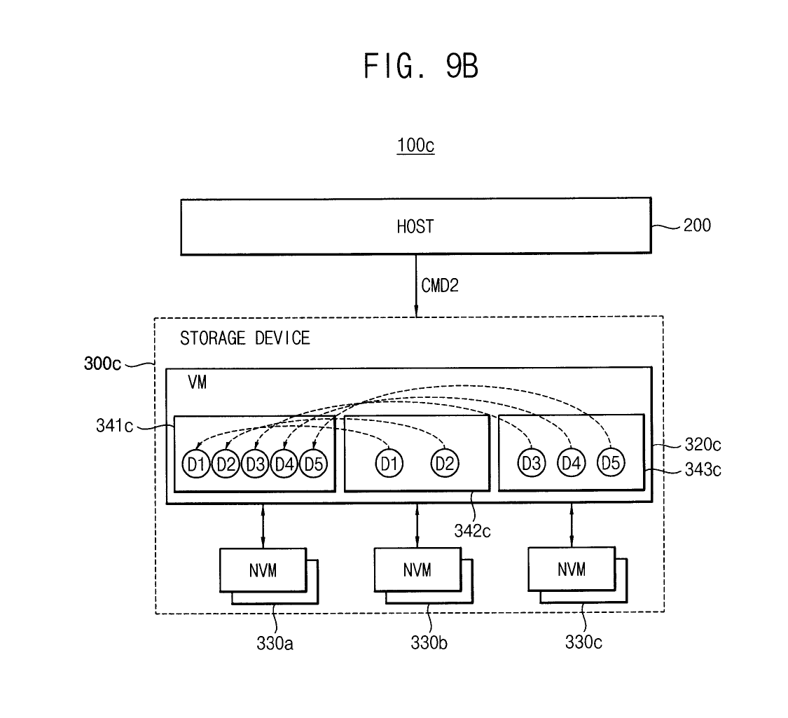

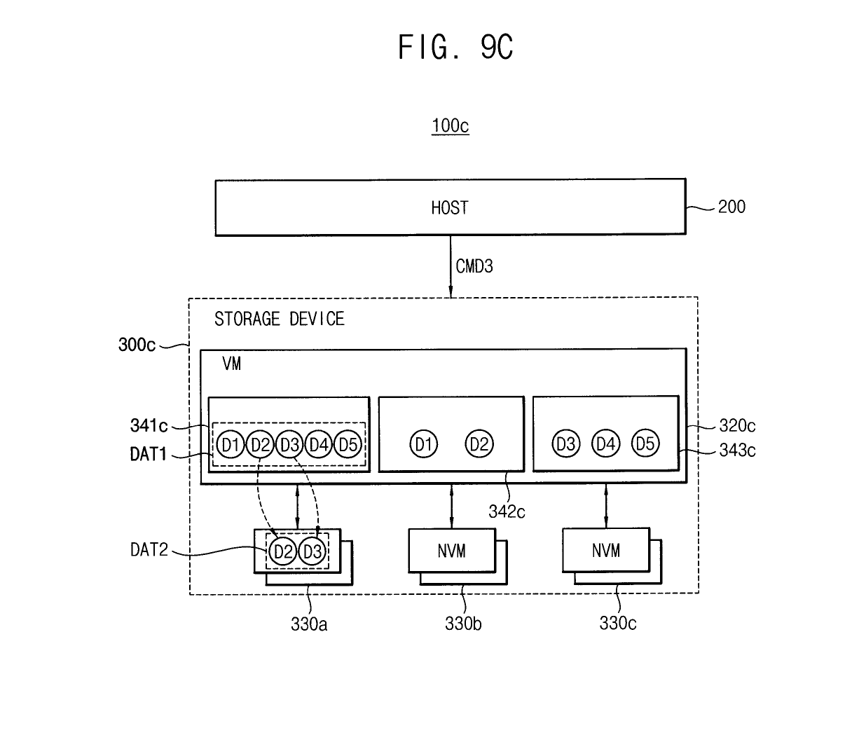

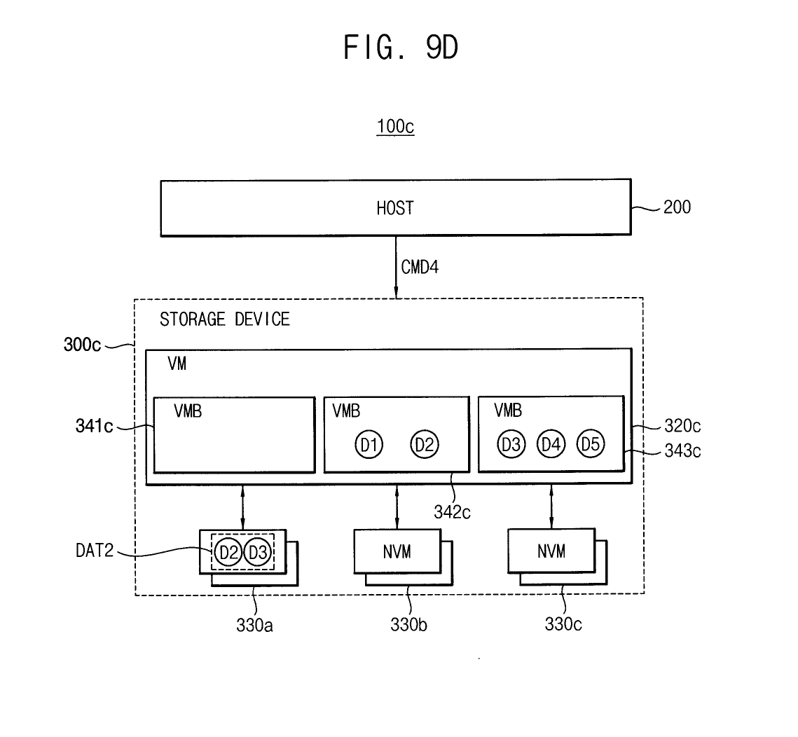

In the foregoing illustrated example, the second control command may include information with respect to an identifier indicating the allocation area, a releasability characteristic of the allocation area, a number of the read data, the respective sizes of the read data and addresses for the first data storage area. The third control command may include information with respect to an identifier indicating the allocation area, an offset of the second data, a number of the accumulated-read data and an address for the second data storage area. The second and third control commands will be explained in some additional detail with reference to FIGS. 9B and 9C.

In the embodiment of FIG. 8, a fourth control command may be further received from the host (S450). The allocation area may be released to delete the accumulated-read data stored in the allocation area in response to the fourth control command (S460). The fourth control command will be explained in some additional detail with reference to FIG. 9D.

FIGS. 9A, 9B, 9C and 9D are conceptual diagrams further describing the method of FIG. 7.

In FIGS. 9A, 9B, 9C and 9D, a computational system 100c includes a host 200 and a storage device 300c. The storage device 300c includes a volatile memory 320c and a plurality of nonvolatile memories 330a, 330b, 330c. For convenience of illustration, some elements in the host 200 and a controller included in the storage device 300c are omitted in FIGS. 9A, 9B, 9C and 9D. It is assumed that the volatile memory 320c is partitioned into three volatile memory blocks 341c, 342c, 343c based on the first control command. Some of the volatile memory blocks 341c, 342c, 343c may correspond to the first data storage area of the storage device 300c, and some of the nonvolatile memories 330a, 330b, 330c may correspond to the second data storage area of the storage device 300c.

Referring to FIG. 9A, in an initial operation time, the first data D1, D2, D3, D4, D5 corresponding to the data migration request are stored in the volatile memory blocks 342c, 343c. The data D1, D2 are stored in the volatile memory block 342c, and the data D3, D4, D5 are stored in the volatile memory block 343c. In this embodiment, the volatile memory blocks 342c, 343c may correspond to the first volatile memory block described with reference to FIG. 8, and may correspond to the first data storage area of the storage device 300c.

Referring to FIG. 9B, the host 200 provides a second control command CMD2 to the storage device 300c. The first data D1, D2, D3, D4, D5 stored in the volatile memory blocks 342c, 343c are read to sequentially accumulate the first data D1, D2, D3, D4, D5 in the allocation area based on the second control command CMD2. In this embodiment, the allocation area may be included in the volatile memory block 341c, and the volatile memory block 341c may correspond to the second volatile memory block described with reference to FIG. 8. For example, the second control command CMD2 may be defined by the following:

CMD2;ID=VM_Read(pn,M,r_addr[ ],siz[ ]). [Equation 2],

where “ID” indicates an identifier of the allocation area included in the second volatile memory block, “VM_Read” indicates a function for reading the first data during the data migration operation, “pn” is a Boolean parameter for the function VM_Read and indicates the releasability of the allocation area, and “M”, “r_addr[ ]”, and “siz[ ]” are integer parameters for the function “VM_Read”. For example, M may be used to indicate a number of the first data, r_addr[ ] may be used to indicate addresses for the first data storage area, and siz[ ] may be used to indicate the size of the first data.

In an embodiment of FIG. 9B, the second control command CMD2 may be defined as “ID#1=VM_Read(pn:1, 5, r_addr[#A, #B, #C, #D, #E], siz[4 KB, 8 KB, 4 KB, 4 KB, 4 KB])”. Five data D1, D2, D3, D4, D5 may be the first data and will be sequentially accumulated in the allocation area included in the volatile memory block 341c. The allocation area may be releasable (e.g., pn:1), and may have the identifier of ID#1. In the initial operation time, the addresses of the first data D1, D2, D3, D4, D5 in the volatile memory blocks 342c, 343c may be #A, #B, #C, #D, #E, respectively. The first data D1, D2, D3, D4, D5 may have the sizes of about 4 KB, 8 KB, 4 KB, 4 KB, 4 KB, respectively.

Referring to FIG. 9C, the host 200 provides a third control command CMD3 to the storage device 300c. A portion D2, D3 of the first data DAT1 accumulated in the allocation area are stored in the nonvolatile memory 330a as the second data DAT2 based on the third control command CMD3. In this embodiment, the nonvolatile memory 330a may correspond to the second data storage area of the storage device 300c. For example, the third control command CMD3 may be defined as follows:

CMD3=VM_Write(ID,ofs,siz,w_addr,urg). [Equation 3],

where “VM_Write” indicates a function for writing the second data during the data migration operation, “ID” indicates the identifier for the allocation area included in the second volatile memory block, and “ofs”, “siz”, “w_addr” and “urg” are integer parameters for the function VM_Write. For example, ofs may be used to indicate an offset for the second data, siz may be used to indicate a number of the second data, w_addr may be used to indicate an address for the second data storage area, and urg may be used to indicate an urgency associated with the write request.

In an embodiment of FIG. 9C, the third control command CMD3 may be defined as VM_Write(ID#1, 1, 2, #x, urg:1). The first data DAT1 accumulated in the allocation area that is included in the volatile memory block 341c and has the identifier of ID#1 may be selected. Two data D2, D3 that are included in the first data DAT1 and located in a point apart from a first one D1 of the first data DAT1 by 1 may be selected, and may be stored in the nonvolatile memory 330a that has the address of #x. The write request may not be urgent (e.g., urg:1).

Referring to FIG. 9D, the host 200 provides a fourth control command CMD4 to the storage device 300c. The allocation area is released to delete the first data DAT1 accumulated in the allocation area based on the fourth control command CMD4. For example, the fourth control command CMD4 may be defined by the following:

CMD4=VM_Unpin(ID). [Equation 4],

where “VM_Unpin” indicates a function for releasing an allocation area after the data migration operation has been successfully completed, and “ID” indicates the identifier for the allocation area included in the second volatile memory block.

In an embodiment of FIG. 9D, the fourth control command CMD4 may be defined as VM_Unpin(ID#1). The allocation area that is included in the volatile memory block 341c and has the identifier of “ID#1” may be released. The first data DAT1 accumulated in the allocation area may be deleted. Consequently, the portion D2, D3 of the first data D1, D2, D3, D4, D5 stored in the volatile memory blocks 342c, 343c may be migrated to the nonvolatile memory 330a using the volatile memory block 341c, without going through the host 200.

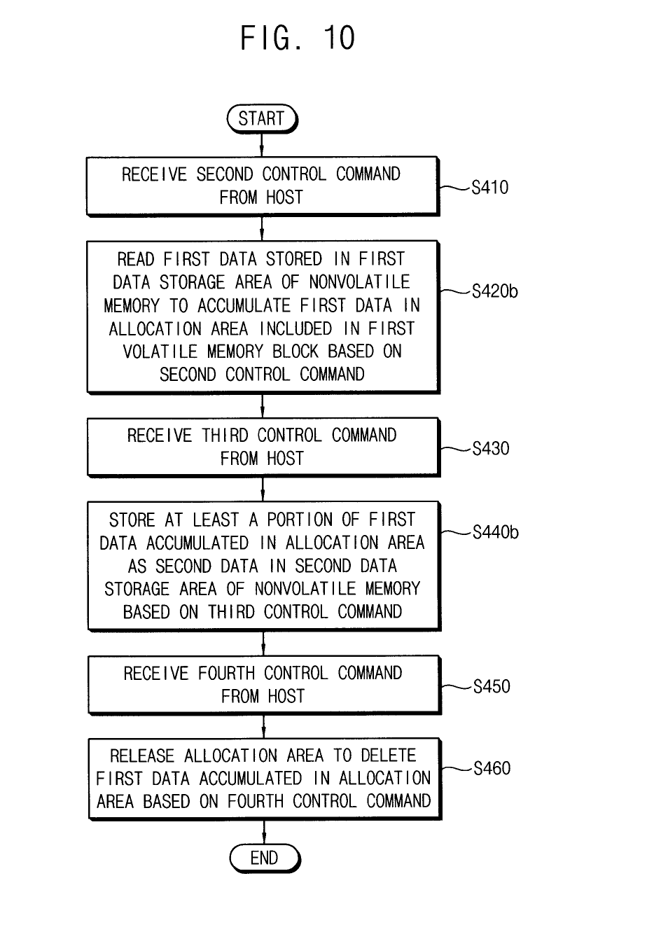

FIG. 10 is a flow chart further describing in another example the step of performing the data migration operation of FIG. 7.

Referring to FIGS. 7 and 10, during the data migration operation, the second control command is received from the host (S410). First data stored in the first data storage area of the nonvolatile memory may be read to accumulate the first data in an allocation area included in a first volatile memory block of the plurality of volatile memory blocks based on the second control command (S420b). A third control command may be received from the host (S430). At least a portion of the first data (e.g., data to be migrated) accumulated in the allocation area may be stored in the second data storage area of the nonvolatile memory as second data based on the third control command (S440b). A fourth control command may be further received from the host (S450). The allocation area may be released to delete the first data accumulated in the allocation area based on the fourth control command (S460).

The steps S410, S430, S450 and S460 for the operating method illustrated in FIG. 10 may be substantially the same as the steps S410, S430, S450 and S460 for the operating method illustrated in FIG. 8. In the embodiment illustrated in FIG. 10, the first data storage area that stores the first data in an initial operation may be included in the nonvolatile memory. The second data storage area that stores the at least a portion of the first data as the second data after the data migration operation may also be included in the nonvolatile memory and may be different from the first data storage area.

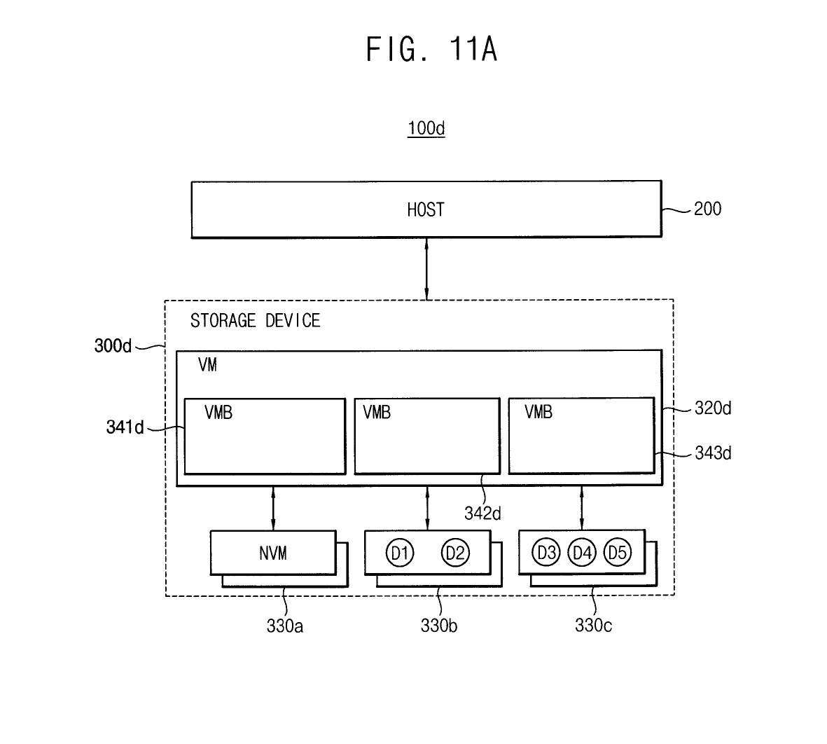

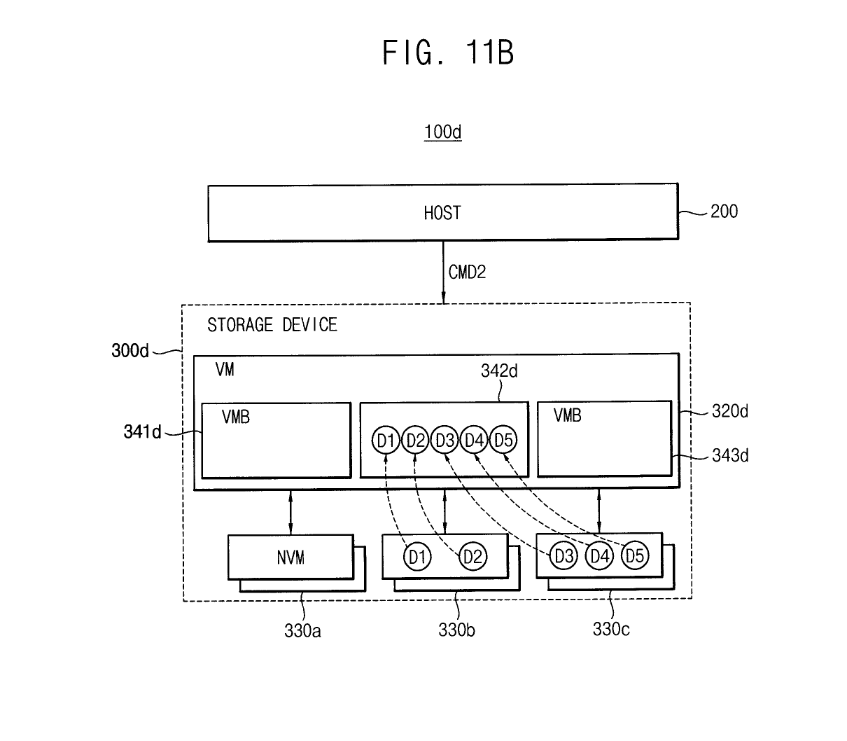

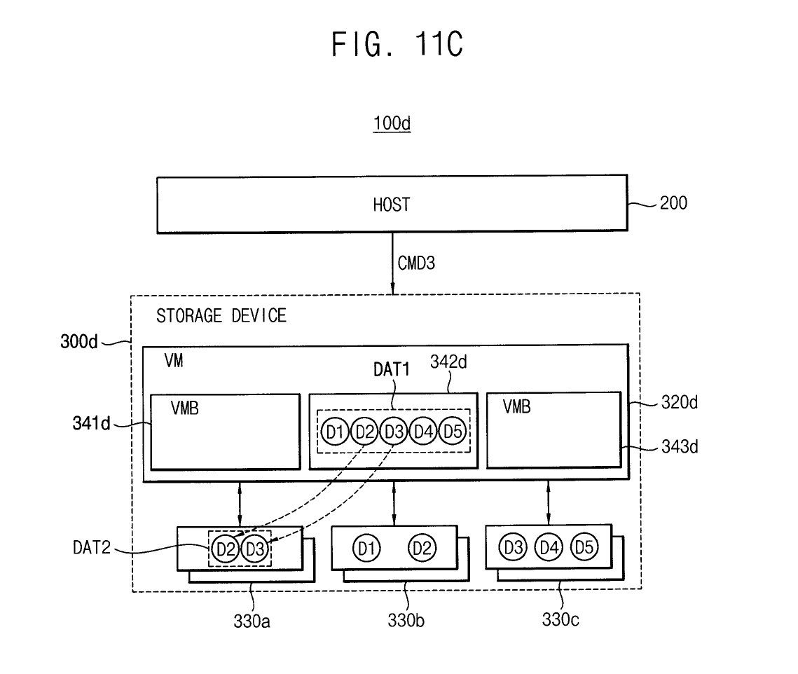

FIGS. 11A, 11B, 11C and 11D are conceptual diagrams further describing the method of FIGS. 7 and 10.

In FIGS. 11A, 11B, 11C and 11D, a computational system 100d includes a host 200 and a storage device 300d. The storage device 300d includes a volatile memory 320d and a plurality of nonvolatile memories 330a, 330b, 330c. For convenience of illustration, some elements in the host 200 and a controller included in the storage device 300d are omitted in FIGS. 11A, 11B, 11C and 11D. It is assumed that the volatile memory 320d is partitioned into three volatile memory blocks 341d, 342d, 343d based on the first control command.

Referring to FIG. 11A, in an initial operation time, the first data D1, D2, D3, D4, D5 corresponding to the data migration request are stored in the nonvolatile memories 330b, 330c. The data D1, D2 are stored in the nonvolatile memory 330b, and the data D3, D4, D5 are stored in the nonvolatile memory 330c. In this embodiment, the nonvolatile memories 330b, 330c may correspond to the first data storage area of the storage device 300d.

Referring to FIG. 11B, the host 200 provides a second control command CMD2 to the storage device 300d. The first data D1, D2, D3, D4, D5 stored in the nonvolatile memories 330b, 330c are read to sequentially accumulate the first data D1, D2, D3, D4, D5 in the allocation area based on the second control command CMD2. In this embodiment, the allocation area may be included in the volatile memory block 342d, and the volatile memory block 342d may correspond to the first volatile memory block described with reference to FIG. 10. The second control command CMD2 may be defined similarly as described above with reference to FIG. 9B.

Referring to FIG. 11C, the host 200 provides a third control command CMD3 to the storage device 300d. A portion D2, D3 of the first data DAT1 accumulated in the allocation area are stored in the nonvolatile memory 330a as the second data DAT2 based on the third control command CMD3. In this embodiment, the nonvolatile memory 330a may correspond to the second data storage area of the storage device 300d. The third control command CMD3 may be defined similarly as described above with reference to FIG. 9C.

Referring to FIG. 11D, the host 200 provides a fourth control command CMD4 to the storage device 300d. The allocation area is released to delete the first data DAT1 accumulated in the allocation area based on the fourth control command CMD4. The fourth control command CMD4 may be defined similarly as described above with reference to FIG. 9D. Consequently, the portion D2, D3 of the first data D1, D2, D3, D4, D5 stored in the nonvolatile memories 330b, 330c may be migrated to the nonvolatile memory 330a using the volatile memory block 342d, without going through the host 200.

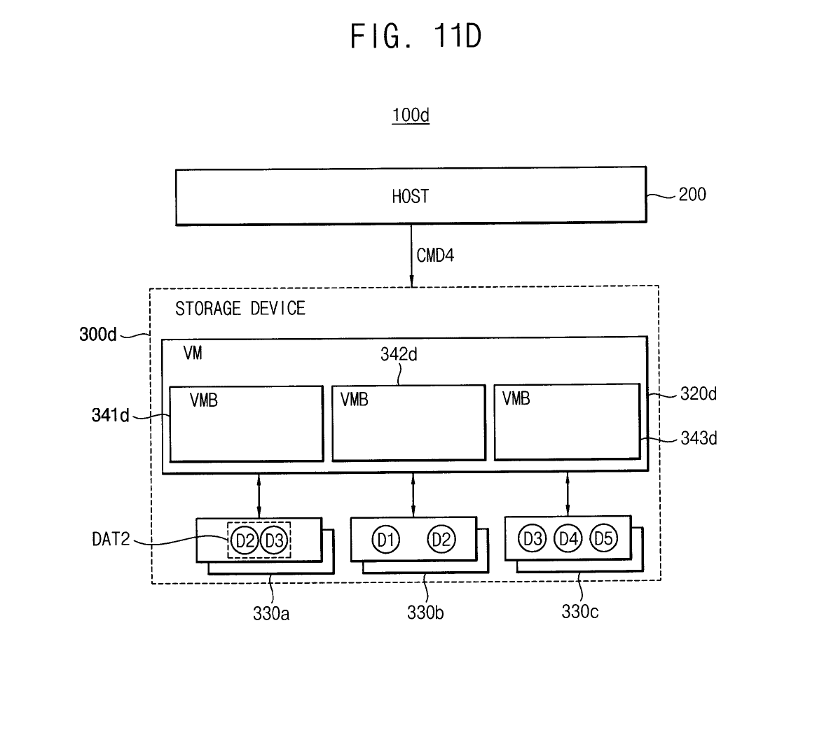

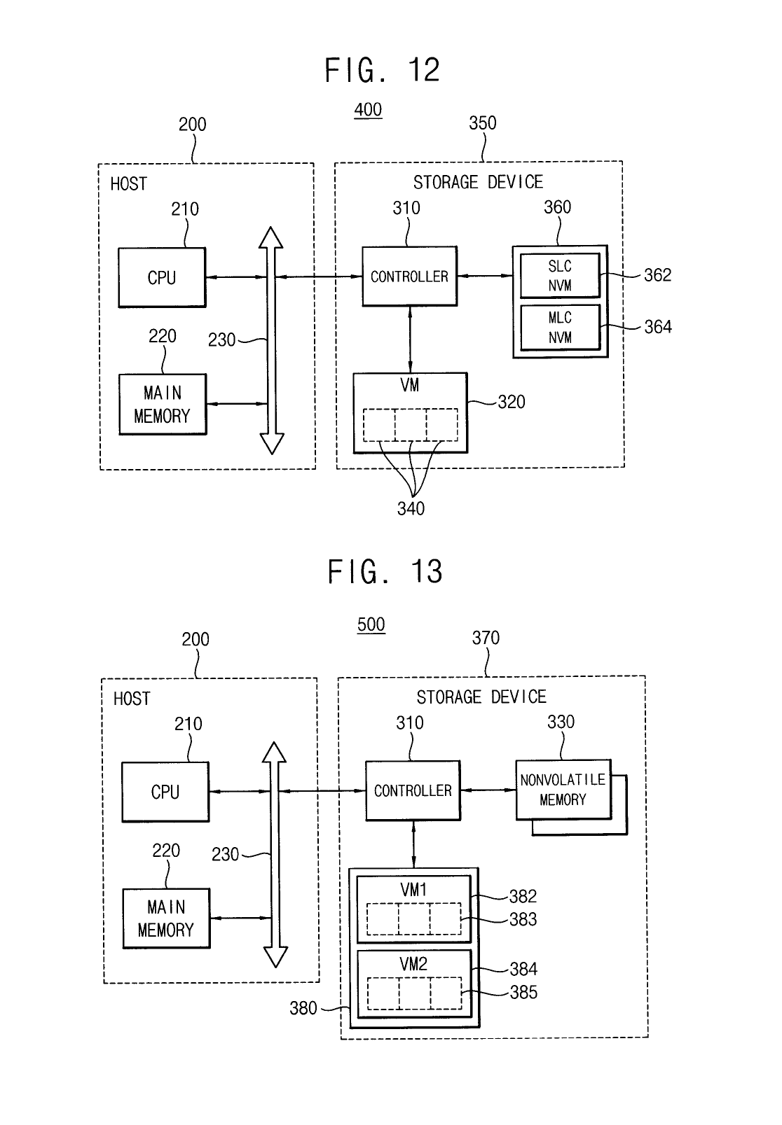

FIGS. 12 and 13 are block diagrams illustrating computational systems including one or more storage device(s) operating in accordance with certain embodiments of the inventive concept.

Referring to FIG. 12, a computational system 400 includes a host 200 and a storage device 350. The host 200 may include a processor 210, a main memory 220 and a bus 230. The storage device 350 may include a controller 310, a volatile memory 320 and at least one nonvolatile memory 360. The processor 210, the main memory 220, the bus 230, the controller 310 and the volatile memory 320 in FIG. 12 may be substantially the same as the processor 210, the main memory 220, the bus 230, the controller 310 and the volatile memory 320 in FIG. 1, respectively. The controller 310 may receive a first control command from the host 200, may partition the volatile memory 320 into a plurality of volatile memory blocks 340 based on the first control command, and may perform a data read operation, a data write operation and/or a data migration operation based on the plurality of volatile memory blocks 340.

The nonvolatile memory 360 may include a first nonvolatile memory 362 and a second nonvolatile memory 364. The first nonvolatile memory 362 may include single-level memory cells (SLCs) in which only one bit is stored in each of memory cells. The second nonvolatile memory 364 may include multi-level memory cells (MLCs) in which more than two bits are stored in each of memory cells.

In the illustrated embodiment, the first nonvolatile memory 362 may store data that are relatively highly accessed (e.g., dynamic data) or are relatively frequently updated (e.g., hot data), and the second nonvolatile memory 364 may store data that are relatively lowly accessed (e.g., static data) or are relatively infrequently updated (e.g., cold data). In another example embodiment, data having relatively small size may be stored in the second nonvolatile memory 364 through the first nonvolatile memory 362, and data having relatively large size may be directly stored in the second nonvolatile memory 364 without going through the first nonvolatile memory 362. In other words, when the data having relatively small size is stored in the second nonvolatile memory 364, the first nonvolatile memory 362 may serve as a cache memory.

Referring to FIG. 13, a computational system 500 includes a host 200 and a storage device 370. The host 200 may include a processor 210, a main memory 220 and a bus 230. The storage device 370 may include a controller 310, a volatile memory 380 and at least one nonvolatile memory 330. The processor 210, the main memory 220, the bus 230, the controller 310 and the nonvolatile memory 330 in FIG. 13 may be substantially the same as the processor 210, the main memory 220, the bus 230, the controller 310 and the nonvolatile memory 330 in FIG. 1, respectively.

The volatile memory 380 may include a first volatile memory 382 and a second volatile memory 384. For example, the first volatile memory 382 may include a memory that has relatively high operation speed (e.g., a SRAM), and may serve as a level 1 (L1) cache memory. The second volatile memory 384 may include a memory that has relatively low operation speed (e.g., a DRAM), and may serve as a level 2 (L2) cache memory.

The controller 310 may receive a first control command from the host 200, may partition the first and second volatile memories 382, 384 into a plurality of volatile memory blocks 383, 385 based on the first control command, respectively, and may perform a data read operation, a data write operation and/or a data migration operation based on the plurality of volatile memory blocks 383, 385.

FIG. 14 is a diagram illustrating a memory card one or more storage device(s) operating in accordance with certain embodiments of the inventive concept.

Referring to FIG. 14, a storage device 700 may include a plurality of connector pins 710, a controller 310, a volatile memory 320 and a nonvolatile memory 330.

The plurality of connector pins 710 may be connected to a host (not illustrated) to transmit and receive signals between the storage device 700 and the host. The plurality of connector pins 710 may include a clock pin, a command pin, a data pin and/or a reset pin.

The controller 310 may receive a first control command from the host, may partition the volatile memory 320 into a plurality of volatile memory blocks 340 based on the first control command, and may perform a data read operation, a data write operation and/or a data migration operation based on the plurality of volatile memory blocks 340.

The storage device 700 may be a memory card, such as a multimedia card (MMC), a secure digital (SD) card, a micro-SD card, a memory stick, an ID card, a personal computer memory card international association (PCMCIA) card, a chip card, an USB card, a smart card, a compact flash (CF) card, etc.

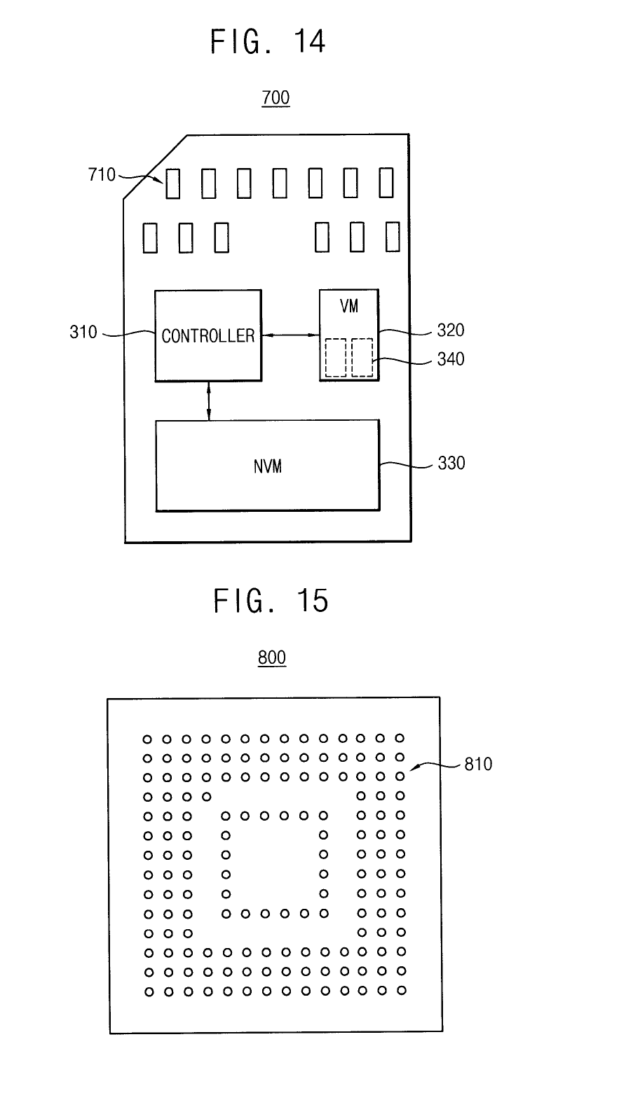

FIG. 15 is a diagram illustrating an embedded multimedia card one or more storage device(s) operating in accordance with certain embodiments of the inventive concept.

Referring to FIG. 15, a storage device 800 may be an embedded multimedia card (eMMC) or a hybrid embedded multimedia card (hybrid eMMC). A plurality of balls 810 may be formed on one surface of the storage device 800. The plurality of balls 810 may be connected to a system board of a host to transmit and receive signals between the storage device 800 and the host. The plurality of balls 810 may include a clock ball, a command ball, a data ball and/or a reset ball. According to certain embodiments, the plurality of balls 810 may be disposed at various locations. The storage device 800, unlike a storage device 700 of FIG. 14 that is attachable and detachable to/from the host, may be mounted on the system board and may not be detached from the system board by a user.

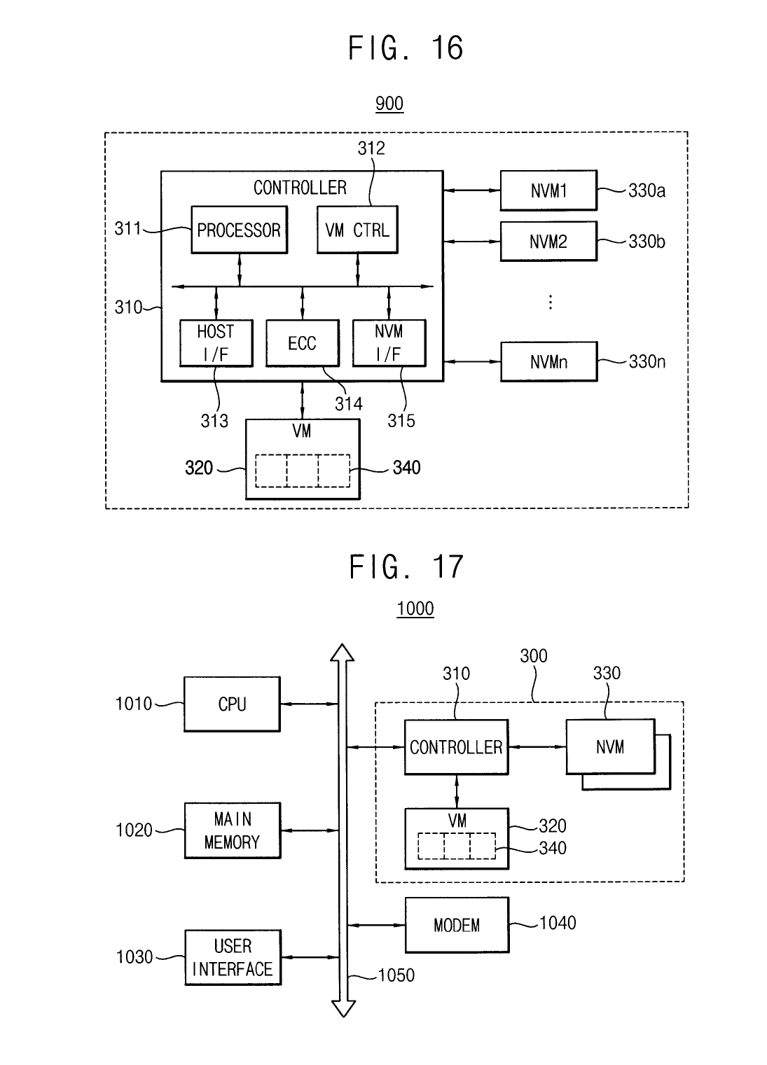

FIG. 16 is a diagram illustrating a solid state drive one or more storage device(s) operating in accordance with certain embodiments of the inventive concept.

Referring to FIG. 16, a storage device 900 includes a controller 310, a volatile memory 320 and a plurality of nonvolatile memories 330a, 330b, . . . , 330n. In certain embodiments, the storage device 900 may be a solid state drive (SSD).

The controller 310 may include a processor 311, a volatile memory controller 312, a host interface 313, an error correction code (ECC) unit 314 and a nonvolatile memory interface 315. The processor 311 may control an operation of the volatile memory 320 via the volatile memory controller 312. Although FIG. 16 illustrates an example where the controller 310 includes the separate volatile memory controller 312, in some embodiments, the volatile memory controller 312 may be included in the processor 311 or in the volatile memory 320. The processor 311 may communicate with a host via the host interface 313, and may communicate with the plurality of nonvolatile memories 330a, 330b, . . . , 330n via the nonvolatile memory interface 315. The host interface 313 may be configured to communicate with the host using at least one of various interface protocols, such as a universal serial bus (USB) protocol, a multi-media card (MMC) protocol, a peripheral component interconnect-express (PCI-E) protocol, a serial-attached SCSI (SAS) protocol, a serial advanced technology attachment (SATA) protocol, a parallel advanced technology attachment (PATA) protocol, a small computer system interface (SCSI) protocol, an enhanced small disk Interface (ESDI) protocol, an integrated drive electronics (IDE) protocol, etc. Although FIG. 16 illustrates an example where the controller 310 communicates with the plurality of nonvolatile memories 330a, 330b, . . . , 330n through a plurality of channels, in some embodiments, the controller 310 communicates with the plurality of nonvolatile memories 330a, 330b, . . . , 330n through a single channel.

The ECC unit 314 may generate an error correction code based on data provided from the host, and the data and the error correction code may be stored in the plurality of nonvolatile memories 330a, 330b, . . . , 330n. The ECC unit 314 may receive the error correction code from the plurality of nonvolatile memories 330a, 330b, . . . , 330n, and may recover original data based on the error correction code. Accordingly, even if an error occurs during data transfer or data storage, the original data may be exactly recovered. According to some embodiments, the controller 310 may be implemented with or without the ECC unit 314.

The controller 310 may receive a first control command from the host, may partition the volatile memory 320 into a plurality of volatile memory blocks 340 based on the first control command, and may perform a data read operation, a data write operation and/or a data migration operation based on the plurality of volatile memory blocks 340.

In some embodiments, the storage devices 700, 800, 900 of FIGS. 14, 15 and 16 may be coupled to a host, such as a mobile device, a mobile phone, a smart phone, a PDA, a PMP, a digital camera, a portable game console, a music player, a desktop computer, a notebook computer, a speaker, a video, a digital television, etc.

FIG. 17 is a block diagram illustrating a system one or more storage device(s) operating in accordance with certain embodiments of the inventive concept.

Referring to FIG. 17, a mobile system 1000 includes a processor 1010, a main memory 1020, a user interface 1030, a modem 1040, such as a baseband chipset, and a storage device 300.

The processor 1010 may perform various computing functions, such as executing specific software for performing specific calculations or tasks. For example, the processor 1010 may be a microprocessor, a central process unit (CPU), a digital signal processor, or the like. The processor 1010 may be coupled to the main memory 1020 via a bus 1050, such as an address bus, a control bus and/or a data bus. For example, the main memory 1020 may be implemented by a DRAM, a mobile DRAM, a SRAM, a PRAM, a FRAM, a RRAM, a MRAM and/or a flash memory. Further, the processor 1010 may be coupled to an extension bus, such as a peripheral component interconnect (PCI) bus, and may control the user interface 1030 including at least one input device, such as a keyboard, a mouse, a touch screen, etc., and at least one output device, a printer, a display device, etc. The modem 1040 may perform wired or wireless communication with an external device. The nonvolatile memory 330 may be controlled by a controller 310 to store data processed by the processor 1010 or data received via the modem 1040. In some embodiments, the mobile system 1000 may further include a power supply, an application chipset, a camera image processor (CIS), etc.

The controller 310 may partition a volatile memory 320 into a plurality of volatile memory blocks 340, and may perform a data read operation, a data write operation and/or a data migration operation based on the plurality of volatile memory blocks 340. Thus, the performance of the storage device 300 and the mobile system 1000 may be improved.

In some embodiments, the storage device 300 and/or components of the storage device 300 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

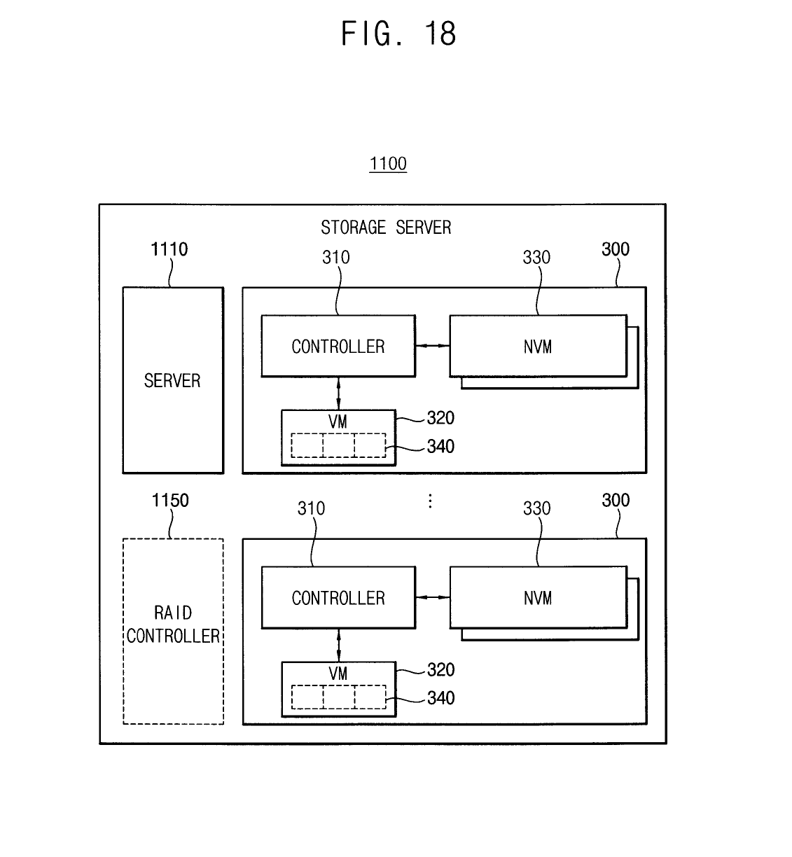

FIG. 18 is a block diagram illustrating a storage server one or more storage device(s) operating in accordance with certain embodiments of the inventive concept.

Referring to FIG. 18, a storage server 1100 may includes a server 1110, a plurality of storage devices 300 which store data for operating the server 1110, and a raid controller 1150 for controlling the storage devices 300.

Redundant array of independent drives (RAID) techniques are mainly used in data servers where important data can be replicated in more than one location across a plurality a plurality of storage devices. The raid controller 1150 may enable one of a plurality of RAID levels according to RAID information, and may interfacing data between the server 1110 and the storage devices 300.

Each of the storage devices 300 may include a controller 310, a volatile memory 320 and a plurality of nonvolatile memories 330. The controller 310 may partition the volatile memory 320 into a plurality of volatile memory blocks 340, and may perform a data read operation, a data write operation and/or a data migration operation based on the plurality of volatile memory blocks 340.

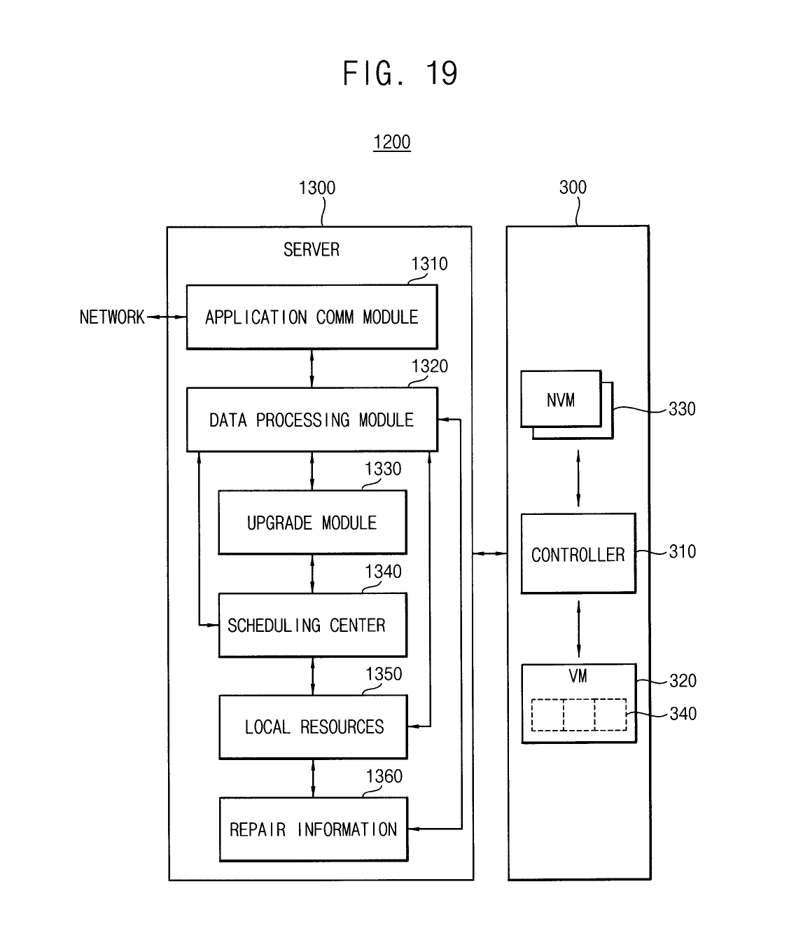

FIG. 19 is a block diagram illustrating a server system one or more storage device(s) operating in accordance with certain embodiments of the inventive concept.

Referring to FIG. 19, a server system 1200 may includes a server 1300 and a storage device 300 which store data for operating the server 1300.

The server 1300 includes an application communication module 1310, a data processing module 1320, an upgrading module 1330, a scheduling center 1340, a local resource module 1350, and a repair information module 1360.

The application communication module 1310 may be implemented for communicating between the server 1300 and a computational system (not illustrated) connected to a network, or may be implemented for communicating between the server 1300 and the storage device 300. The application communication module 1310 transmits data or information received through user interface to the data processing module 1320.

The data processing module 1320 is linked to the local resource module 1150. The local resource module 1350 may provide a user with repair shops, dealers and list of technical information based on the data or information input to the server 1300.

The upgrading module 1330 interfaces with the data processing module 1320. The upgrading module 1330 may upgrade firmware, reset code or other information to an appliance based on the data or information from the storage device 300.

The scheduling center 1340 permits real-time options to the user based on the data or information input to the server 1300.

The repair information module 1360 interfaces with the data processing module 1320. The repair information module 1360 may provide the user with information associated with repair (for example, audio file, video file or text file). The data processing module 1320 may pack associated information based on information from the storage device 300. The packed information may be sent to the storage device 300 or may de displayed to the user.

The storage device 300 includes a controller 310, a volatile memory 320 and a plurality of nonvolatile memories 330. The controller 310 may partition the volatile memory 320 into a plurality of volatile memory blocks 340, and may perform a data read operation, a data write operation and/or a data migration operation based on the plurality of volatile memory blocks 340.

The above described embodiments of the inventive concept may be applied to any storage device including a volatile memory device, such as a memory card, a solid state drive, an embedded multimedia card, a hybrid embedded multimedia card, a universal flash storage, a hybrid universal flash storage, etc.

The foregoing is illustrative of example embodiments and is not to be construed as limiting thereof. Although a certain embodiments have been described, those skilled in the art will readily appreciate that many modifications are possible materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of operating a storage device including a volatile memory and a nonvolatile memory, the method comprising:
partitioning the volatile memory into a plurality of volatile memory blocks in response to a control command received from a host; and thereafter,
performing a data read operation that retrieves read data from the nonvolatile memory, stores the retrieved read data in a first volatile memory block among the plurality of volatile memory blocks, and then provides the read data stored in the first volatile memory block to the host.

2. The method of claim 1, wherein the control command includes information identifying; a number of the plurality of volatile memory blocks, a type for each volatile memory block, a management policy for each volatile memory block, and a size for each volatile memory block.

3. The method of claim 2, wherein the type for each volatile memory block is one of a read only type, a read/write type, a database type, and a guest operating system (OS) type.

4. The method of claim 3, wherein the management policy for each volatile memory block is one of a least recently used (LRU) algorithm, a most recently used (MRU) algorithm and a first-in first-out (FIFO) algorithm.

5. The method of claim 4, wherein a data type of the read data corresponds with a type of the first volatile memory block, and the read data is stored in the first volatile memory block using the management policy for the first volatile memory block and in accordance with the size of the first volatile memory block.

6. The method of claim 1, wherein the storage device is a solid state drive (SSD) or a memory card.

7. The method of claim 1, wherein the volatile memory includes at least one of a dynamic random access memory (DRAM) and a static random access memory (SRAM).

8. The method of claim 1, wherein the nonvolatile memory includes at least one of a NAND flash memory, a NOR flash memory, a phase change random access memory (PRAM), a resistance random access memory (RRAM), a magnetic random access memory (MRAM) and a ferroelectric random access memory (FRAM).

9. A method of operating a storage device including a volatile memory and a nonvolatile memory, the method comprising:
partitioning the volatile memory into a plurality of volatile memory blocks in response to a control command received from a host; and thereafter,
performing a data write operation that stores write data received from the host in a first volatile memory block among the plurality of volatile memory blocks, and then stores the write data stored in the first volatile memory block in the nonvolatile memory.

10. The method of claim 9, wherein the control command includes information identifying; a number of the plurality of volatile memory blocks, a type for each volatile memory block, a management policy for each volatile memory block, and a size for each volatile memory block.

11. The method of claim 10, wherein the type for each volatile memory block is one of a read only type, a read/write type, a database type, and a guest operating system (OS) type.

12. The method of claim 11, wherein the management policy for each volatile memory block is one of a least recently used (LRU) algorithm, a most recently used (MRU) algorithm and a first-in first-out (FIFO) algorithm.

13. The method of claim 12, wherein a data type of the write data corresponds with a type of the first volatile memory block, and the write data is stored in the first volatile memory block using the management policy for the first volatile memory block and in accordance with the size of the first volatile memory block.

14. A method of operating a storage device including a volatile memory and a nonvolatile memory, the method comprising:
partitioning the volatile memory into a plurality of volatile memory blocks including a first volatile memory block and a second volatile memory block; and thereafter,
performing a data migration operation comprising:
reading first data from a first data storage area of the nonvolatile memory and storing the first data in the first volatile memory block;
accumulating the first data in an allocation area of the second volatile memory block as second data; and then,
storing at least a portion of the second data in a second data storage area of the nonvolatile memory different from the first data storage area.

15. The method of claim 14, further comprising:
releasing the allocation area of the second volatile memory block to delete the second data.

16. The method of claim 15, wherein the partitioning of the volatile memory is performed in response to a first control command received from a host that includes information identifying a number of the plurality of volatile memory blocks, a type for each volatile memory block, a management policy for each volatile memory block, and a size for each volatile memory block.

17. The method of claim 16, wherein the accumulating of the first data in the allocation area is performed in response to a second control command received from the host that includes information identifying the allocation area, indicating releasability of the allocation area, a number of the first data, and respective sizes and addresses for the first data.

18. The method of claim 17, wherein storing of the at least a portion of the second data in the second data storage area is performed in response to a third control command received from the host that includes information identifying the allocation area, an offset for the second data, a number of the second data and an address for the second data storage area.

19. The method of claim 18, wherein releasing the allocation area of the second volatile memory block is performed in response to a fourth control command received from the host.

20. The method of claim 19, wherein the storage device is a solid state drive (SSD) or a memory card, the volatile memory includes at least one of a dynamic random access memory (DRAM) and a static random access memory (SRAM), and the nonvolatile memory includes at least one of a NAND flash memory, a NOR flash memory, a phase change random access memory (PRAM), a resistance random access memory (RRAM), a magnetic random access memory (MRAM) and a ferroelectric random access memory (FRAM).
